(19) United States
(12) Patent Application Publication
(10) Pub. No.: US 2023/0156539 A1
(43) Pub. Date: May 18, 2023

(54) METHOD AND APPARATUS FOR FAILURE REPORT

(71) Applicant: Lenovo (Beijing) Ltd., Beijing (CN)

(72) Inventors: Lianhai Wu, Chaoyang (CN); Jie Shi, Haidian District (CN); Haiming Wang, Xicheng District (CN); Jing Han, Chaoyang District (CN); Ran Yue, Haidian District (CN)

(73) Assignee: Lenovo (Beijing) Ltd., Beijing (CN)

(21) Appl. No.: 17/916,902

(22) PCT Filed: Apr. 9, 2020
(86) PCT No.: PCT/CN2020/083987

§ 371 Date: Oct. 4, 2022

(51) Int. Cl. H04W 36/00; H04W 76/19; H04W 24/10; H04W 36/30

(52) U.S. Cl. CPC H04W 36/0079; H04W 76/19; H04W 24/10; H04W 36/305

(57) ABSTRACT

Embodiments of the present application relate to a method and an apparatus for failure report. According to an embodiment of the present application, a method can include: in response to accessing a cell by a radio resource control (RRC) re-establishment procedure or a connection setup procedure, receiving a user equipment (UE) information request; and in response to the UE information request, transmitting a UE information response message including a radio link failure (RLF) report, wherein the RLF report indicates failure information being at least one of: a RLF, a handover failure (HOF), a first timer associated with a fast master cell group (MCG) link recovery procedure expiry, a dual active protocol stack (DAPS) HOF, and a conditional handover (CHO) failure. Embodiments of the present application can solve failure report problems in emerging communication scenarios, and can facilitate and improve the implementation of 5G new radio (NR) technology.

### TECHNICAL FIELD

Embodiments of the present application generally relate to wireless communication technology, especially to a method and an apparatus for failure report e.g., for radio link failure (RLF) report and secondary cell group (SCG) failure report.

### BACKGROUND

When a RLF or handover failure (HOF) occurs for a UE, the UE may perform a radio resource control (RRC) re-establishment procedure. The UE may access a cell by a successful RRC re-establishment procedure, or access a cell by a connection setup procedure in response to an unsuccessful a RRC re-establishment procedure. The accessed network will request UE information including RLF report of the UE such that the network can optimize the mobility problem based on the UE information from the UE. Accordingly, the UE will transmit a RLF report to the network. However, what information should be included in the RLF report when considering a fast MCG link recovery procedure and a CHO procedure has not been discussed in 3rd generation partnership project (3GPP) 5G new radio (NR) technology yet.

In addition, in 3GPP Release 16, a multi-radio dual connectivity (MR-DC) operation is supported. In MR-DC, the UE may perform conditional primary secondary cell (PScell) change (CPC) procedure to change the serving PScell. However, what information should be included in a SCG failure report when the CPC failure occurs has not been discussed in 3GPP 5G NR technology yet, either.

Therefore, the industry desires an improved technology for failure report, e.g., for RLF report and SCG failure report, so as to the needed information can be clearly included in the RLF report and SCG failure report to optimize mobility problems in emerging communication scenarios.

### SUMMARY

Some embodiments of the present application provide a technical solution for failure report, e.g., for RLF report and SCG failure report.

According to some embodiments of the present application, a method may include: in response to accessing a cell by a radio resource control (RRC) re-establishment procedure or a connection setup procedure, receiving a UE information request; and in response to the UE information request, transmitting a UE information response message including a RLF report. The RLF report indicates failure information being at least one of: a RLF, a HOF, a first timer associated with a fast MCG link recovery procedure expiry, a dual active protocol stack (DAPS) HOF, and a CHO failure.

According to some other embodiments of the present application, a method may include: receiving CPC configuration information associated with a serving PScell, wherein the CPC configuration information indicates a set of CPC configurations and a set of execution conditions for a set of cells, wherein each cell is associated with a CPC configuration and an execution condition; evaluating the set of execution conditions based on the CPC configuration information; in response to at least one execution condition of the set of execution conditions is met, performing a CPC procedure for a cell associated with one met execution condition and starting a fourth timer associated with the CPC procedure; and in response to the fourth timer expires, transmitting SCG failure information indicating the CPC failure.

According to some other embodiments of the present application, a method may include: transmitting a UE information request; and in response to the UE information request, receiving a UE information response message including a RLF report, wherein the RLF report indicates failure information being at least one of: a RLF, a HOF, a first timer associated with a fast MCG link recovery procedure expiry, a DAPS HOF, and a CHO failure.

According to some other embodiments of the present application, a method may include: transmitting CPC configuration information associated with a serving PScell, wherein the CPC configuration information indicates a set of CPC configurations and a set of execution conditions for a set of cells, wherein each cell is associated with a CPC configuration and an execution condition; and receiving SCG failure information indicating a CPC failure.

Some embodiments of the present application also provide an apparatus, include: at least one non-transitory computer-readable medium having computer executable instructions stored therein, at least one receiving circuitry; at least one transmitting circuitry; and at least one processor coupled to the at least one non-transitory computer-readable medium, the at least one receiving circuitry and the at least one transmitting circuitry. The computer executable instructions are programmed to implement any method as stated above with the at least one receiving circuitry, the at least one transmitting circuitry and the at least one processor.

Embodiments of the present application provide a technical solution for failure report, e.g., for RLF report and SCG failure report. Accordingly, embodiments of the present application can solve failure report problems in emerging communication scenarios, and can facilitate and improve the implementation of 5G NR technology.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system in accordance with some embodiments of the present application;

FIG. 2 illustrates an exemplary flowchart of a fast MCG link recovery procedure in accordance with some embodiments of the present application;

FIG. 3 illustrates an exemplary flowchart of a CHO procedure in accordance with some embodiments of the present application;

FIG. 4 illustrates an exemplary flowchart of a UE information reporting procedure in accordance with some embodiments of the present application;

FIG. 5 illustrates a flow chart of a method for RLF report in accordance with some embodiments of the present application;

FIG. 6 illustrates a flow chart of a method for SCG failure report in accordance with some embodiments of the present application;

FIG. 7 illustrates a simplified block diagram of an apparatus 700 for RLF report according to some embodiments of the present application; and

FIG. 8 illustrates a simplified block diagram of an apparatus 800 for SCG failure report according to some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3GPP 5G, 3GPP LTE Release 8 and so on. It is contemplated that along with developments of network architectures and new service scenarios, all embodiments in the present application are also applicable to similar technical problems; and moreover, the terminologies recited in the present application may change, which should not affect the principle of the present application.

Next generation radio access network (NG-RAN) supports multi-radio dual connectivity (MR-DC) operation. In the MR-DC operation, a UE with multiple transceivers may be configured to utilize resources provided by two different nodes connected via non-ideal backhauls. Wherein one node may provide NR access and the other one node may provide either evolved-universal mobile telecommunication system (UMTS) terrestrial radio access (UTRA) (E-UTRA) or NR access. One node may act as a master node (MN) and the other node may act as a secondary node (SN). The MN and SN are connected via a network interface (for example, Xn interface as specified in 3GPP standard documents), and at least the MN is connected to the core network.

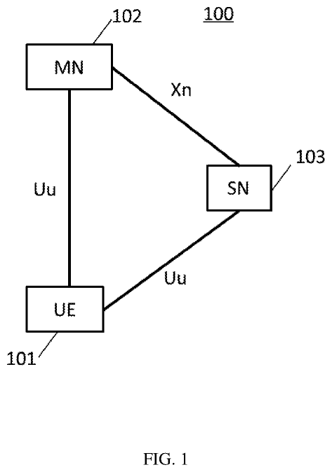

For example, FIG. 1 illustrates a schematic diagram of a wireless communication system in accordance with some embodiments of the present application.

As shown in FIG. 1, the wireless communication system 100 may be a dual connectivity system 100 includes at least one user equipment (UE) 101, at least one MN 102, and at least one SN 103. In particular, the dual connectivity system 100 in FIG. 1 includes one shown UE 101, one shown MN 102, and one shown SN 103 for illustrative purpose. Although a specific number of UEs 101, MNs 102, and SNs 103 are depicted in FIG. 1, it is contemplated that any number of UEs 101, MNs 102, and SNs 103 may be included in the wireless communication system 100.

Referring to FIG. 1, the UE 101 may connect to the MN 102 and the SN 103 via a network interface, for example, Uu interface as specified in 3GPP standard documents. The MN 102 and the SN 103 may be connected with each other via a network interface, for example, Xn interface as specified in 3GPP standard documents. The MN 102 may be connected to the core network via a network interface (not shown in FIG. 1). The UE 102 may be configured to utilize resources provided by the MN 102 and the SN 103 to perform data transmission.

The MN 102 may refer to a radio access node that provides a control plane connection to the core network. In an embodiment of the present application, in the E-UTRA-NR DC (EN-DC) scenario, the MN may be an eNB. In another embodiment of the present application, in the next generation E-UTRA-NR DC (NGEN-DC) scenario, the MN may be an ng-eNB. In yet another embodiment of the present application, in the NR-DC scenario or the NR-E-UTRA DC (NE-DC) scenario, the MN may be a gNB.

The MN may be associated with a MCG. The MCG may refer to a group of serving cells associated with the MN, and may include a primary cell (PCell) and optionally one or more secondary cells (SCells). The PCell may provide a control plane connection to the UE 101.

The SN 103 may refer to a radio access node without control plane connection to the core network but providing additional resources to the UE. In an embodiment of the present application, in the EN-DC scenario, the SN may be an en-gNB. In another embodiment of the present application, in the NE-DC scenario, the SN may be a ng-eNB. In yet another embodiment of the present application, in the NR-DC scenario or the NGEN-DC scenario, the SN may be a gNB.

The SN may be associated with a secondary cell group (SCG). The SCG may refer to a group of serving cells associated with the SN, and may include a primary secondary cell (PSCell) and optionally one or more secondary cells (SCells).

The PCell of the MCG and the PSCell of the SCG may also be referred to as a special cell (SpCell).

In some embodiments of the present application, the UE 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. In some other embodiments of the present application, the UE 101 may include a portable wireless communication device, a smart phone, a cellular telephone, a flip phone, a device having a subscriber identity module, a personal computer, a selective call receiving circuitry, or any other device that is capable of sending and receiving communication signals on a wireless network. In some other embodiments of the present application, the UE 101 may include wearable devices, such as smart watches, fitness bands, optical head-mounted displays, or the like. Moreover, the UE 101 may be referred to as a subscriber unit, a mobile, a mobile station, a user, a terminal, a mobile terminal, a wireless terminal, a fixed terminal, a subscriber station, a user terminal, or a device, or described using other terminology used in the art.

In 3GPP Release 16, a fast MCG link recovery procedure is introduced for MR-DU. The purpose of this procedure is to inform a RLF in a MCG to the MN via a SN connected to the UE, such that the UE in RRC_CONNECTED state may initiate the fast MCG link recovery procedure to quickly continue the RRC connection without performing a re-establishment procedure.

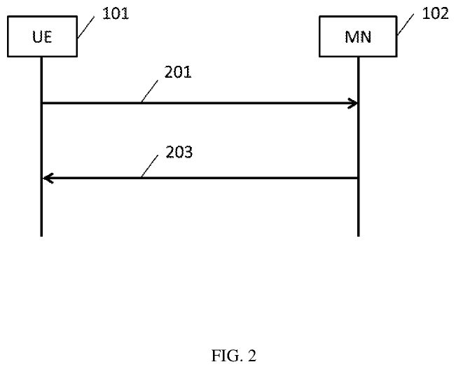

For example, FIG. 2 illustrates an exemplary flowchart of a fast MCG link recovery procedure in accordance with some embodiments of the present application.

As shown in FIG. 2, in the case that a RLF in a MCG for the UE 101 happens, the UE 101 may initiate (or, trigger) a fast MCG link recovery procedure. For example, in step 201, the UE 101 may transmit a message associated with the RLF to the MN 102 via the SN 103. In an embodiment of the present application, the RLF in the MCG may refer to the RLF happening in the PCell of the MCG. In an embodiment of the present application, the message associated with the RLF in step 201 may be a MCGFailureInformation message as specified in 3GPP standard documents. The UE 101 may not directly transmit the message associated with the RLF to the MN 102. Instead, the UE 101 may transmit the message associated with the RLF to the SN 103, and then the SN 103 may transfer the message received from the UE to the MN 102.

For example, the UE may be configured with a split signaling radio bearer (SRB) 1 or SRB3 to report the MCG failure information when a RLF in the MCG happens. In the case that split SRB1 is configured, the UE 101 may submit the MCGFailureInformation message to low layers, e.g., for transmission via SRB1. In the case that SRB3 is configured, the UE 101 may submit the MCGFailureInformation message to low layers for transmission via SRB3. For example, the MCGFailureInformation message may be embedded in NR RRC message ULInformationTransferMRDC as specified in 3GPP standard documents for transmission via SRB3.

When or after transmitting the message in step 201, the UE 201 may start a timer associated with a fast MCG link recovery procedure. In an embodiment of the present application, the timer associated with a fast MCG link recovery procedure may be T316 as specified in 3GPP standard documents.

After receiving the message associated with the RLF, in step 202, the MN 102 may transmit a response message to the UE 101. The response message in step 202 may be a RRC reconfiguration message including a handover (HO) command for a cell or a RRC release message. In an embodiment of the present application, the handover command may be a reconfigurationWithSync configuration as specified in 3GPP standard documents. The MN 102 may not directly transmit the response message to the UE 101. Instead, the MN 102 may transmit the response message to the SN 103, and then the SN 103 may transfer the response message to the UE 101.

For example, in the case that SRB3 is configured for transmitting the message associated with the RLF, after receiving the response message from the MN 102, the SN 103 may encapsulate the response message in a DLInformationTransferMRDC message as specified in 3GPP standard documents, and then transmit the DLInformationTransferMRDC message to the UE 101.

Before the timer, e.g., T316 expires, in the case that the UE 101 receives one of the RRC reconfiguration message or the RRC release message, the UE 101 shall stop the timer, which means that the fast MCG link recovery procedure is terminated. In the case that the UE 101 receives the RRC reconfiguration message including handover command for a cell, the UE may perform handover for the UE to the cell. In the case that the UE 101 receives the RRC release message, then the UE shall enter a RRC_IDLE state.

The UE does not receive any response message from the MN 102 before the timer expires in some embodiments of the present application. The UE 101 performs a RRC re-establishment procedure after the timer expires.

In addition, the UE 101 may also be configured with a CHO procedure. The CHO procedure is defined as a handover procedure that is executed by the UE when one or more handover execution conditions are met. In the CHO procedure, a UE may start evaluating execution condition(s) after receiving the CHO configuration information, and stop evaluating the execution condition during the CHO execution once the execution condition(s) is met.

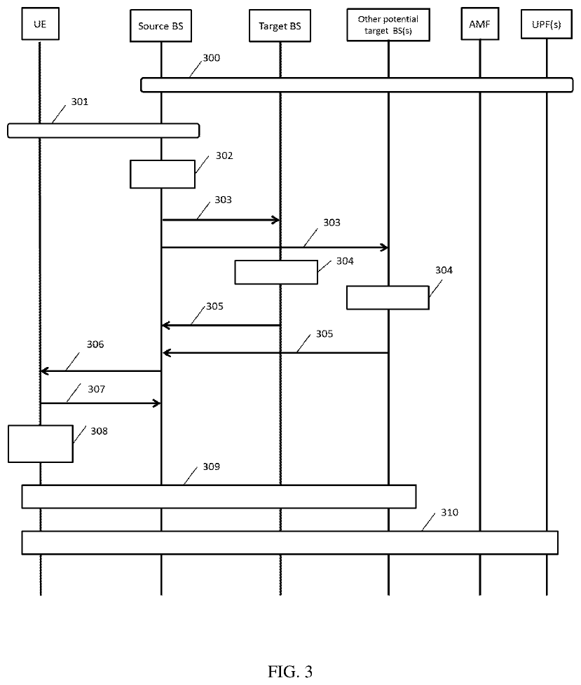

For example, FIG. 3 illustrates an exemplary flowchart of a CHO procedure in accordance with some embodiments of the present application. As shown in FIG. 3, it depicts a basic conditional handover scenario where neither the access and mobility management function (AMF) nor the user plane functions (UPFs) changes.

Referring to FIG. 3, in step 300, an AMF may provide the UE context of a UE to the source base station (BS). The UE context may contain information regarding roaming and access restrictions of the UE.

In step 301, the source BS may transmit measurement configuration information to the UE. The UE may report the measurement result to the source BS based on the measurement configuration information.

In step 302, the source BS may decide to use a CHO for the UE, which may be based on the measurement result reported by the UE.

In step 303, the source BS may transmit a CHO request message to one or more candidate BSs. For example, the one or more candidate BSs may include a target BS and other potential target BS(s).

In step 304, the target BS and other potential target BS(s) may perform admission control to decide whether to allow the CHO of the UE after receiving the CHO request message from the source BS.

In step 305, based on the admission control result, at least one of the target BS and other potential target BS(s) may transmit a CHO response message to the source BS. The CHO response message may include CHO configuration for one or more candidate cells.

In step 306, the source BS may transmit a RRC reconfiguration message to the UE. The RRC reconfiguration message may include conditional handover (CHO) configuration information indicating a set of CHO configurations and a set of execution conditions for a set of cells, each cell is associated with a CHO configuration and an execution condition. The set of cells may include the one or more candidate cells provided by at least one of the target BS and other potential target BS(s).

The CHO configuration associated with a cell may include parameters for the UE to perform handover to the cell. For example, the CHO configuration associated with a cell may include parameters for the UE to access the cell and/or perform data transmission with the cell.

The execution condition may include one or two trigger conditions. For example, in the case that the execution condition includes one trigger condition, the trigger condition may be an A3 event or an A5 event as specified in 3GPP standard document TS38.331. In the case that the execution condition includes two trigger conditions, the two trigger conditions may be an A3 event and an A5 event as specified in 3GPP standard document TS38.331. In addition, only a single reference signal (RS) type may be used for evaluating the execution condition of a single cell and at most two different execution quantities can be configured simultaneously for evaluating the execution condition of a single cell. For example, the two different execution quantities may be reference signal receiving power (RSRP) and reference signal receiving quality (RSRQ), or RSRP and signal to interference plus noise ratio (SINR), or the like. In some embodiments of the present application, more than one execution condition may be satisfied, that is, more than one cell is suitable for the UE's handover. In this case, the UE can select a cell for performing CHO based on the execution quantity.

After receiving the RRC reconfiguration message, in step 307, the UE may transmit a RRC reconfiguration complete message to the source BS.

In step 308, the UE may maintain the connection with the source BS and start evaluating the set of execution conditions for the set of cells. Before any execution condition is satisfied, when receiving a handover (HO) command without CHO configuration, the UE may perform the HO procedure regardless of any previously received CHO configuration information. Otherwise, in the case that at least one execution condition for at least one cell is satisfied, in step 309, the UE may detach from the source BS and perform (or apply) a CHO procedure to a cell selected from the at least one cell. The selected cell may be referred to as a target cell.

Performing a CHO procedure to the selected cell may include applying the corresponding CHO configuration for the selected cell. When performing the CHO procedure, e.g., from the time when the UE starts synchronization with the selected cell, the UE does not monitor the source BS anymore. The UE may complete the CHO procedure by transmitting a RRC reconfiguration complete message to the target cell.

In step 310, the UE, the source BS, the target BS, and the core network (e.g., AMF and/or UPF(s)) may perform data forwarding and path switch.

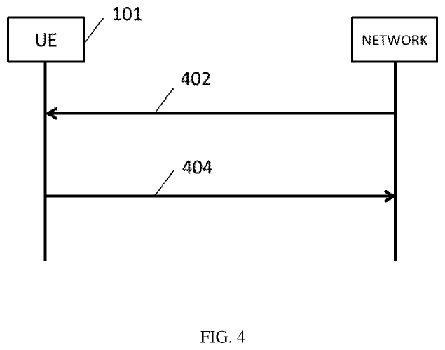

When a failure, e.g., a RLF or a HOF occurs for a UE, the UE will store the information related to the failure so as to report the related information to the network for mobility optimization. FIG. 4 illustrates an exemplary flowchart of a UE information reporting procedure in accordance with some embodiments of the present application.

As shown in FIG. 4, after a failure, e.g., a RLF or a HOF occurs for a UE, the UE will try to perform a re-establishment procedure (also referred to as a RRC re-establishment procedure) in a cell. When the re-establishment procedure succeeds, the UE can access the network by the successful re-establishment procedure. When the re-establishment procedure fails, the UE can access the network by a connection setup procedure. For example, the UE may enter a RRC_IDLE state and select a cell for accessing the network. Regardless of whether the re-establishment procedure succeeds or fails, the network would like to receive the information related to the failure, e.g., RLF and/or HOF from the UE after the UE accessed the network, such that the network can optimize the mobility problem based on the information from the UE. For example, in step 402, the network may transmit a UE information request to the UE. After receiving the UE information request, in step 404, the UE may transmit a UE information response to the network. The UE information response may include a failure report (also referred to as a RLF report) including the information related to the failure, e.g., a RLF and/or HOF etc.

Embodiments of the present application can define the information included in the RLF report in various scenarios, for example, for failures happened when a MCG link recovery procedure and/or a CHO procedure are configured for the UE. More details on embodiments of the present application will be illustrated in the following text in combination with the appended drawings.

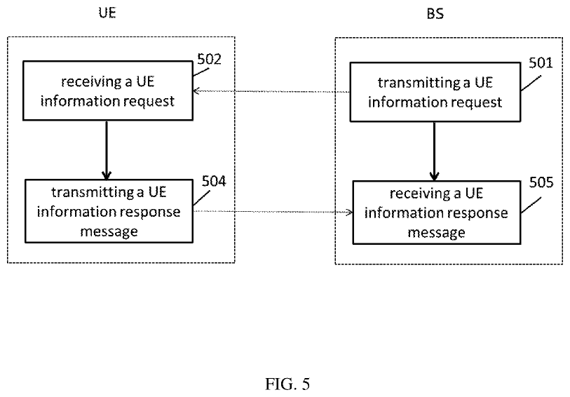

FIG. 5 illustrates a flow chart of a method for RLF report in accordance with some embodiments of the present application. The method may be performed between a UE 101 as shown in FIG. 1 and a network accessed by a UE 101 through a RRC re-establishment procedure or a connection setup procedure. For example, the UE 101 may be in the MR-DC scenario where the UE 101 is connected to an MN 102 and an SN 103. In addition, persons skilled in the art should understand although the method is illustrated in the system level in FIG. 5, the method performed in UE 101 and that performed in the network side (e.g., the BS) are separated. They can be applied in other network elements and can incorporate with other corresponding methods.

As shown in FIG. 5, in step 501, the BS may transmit a UE information request to a UE 101, which accesses the network via a RRC re-establishment procedure or a connection set-up procedure. In step 502, the UE 101 may receive a UE information request. In an embodiment of the present application, for the UE, the UE information request may be received in response to accessing a cell by a re-establishment procedure. In another embodiment of the present application, for the UE, the UE information request may be received in response to accessing a cell by a connection setup procedure. The connection setup procedure may occur after that the re-establishment procedure fails. That is, after the re-establishment procedure fails, the UE enters a RRC_IDLE state and initiates a connection setup procedure to access the network.

In response to the UE information request, in step 504, the UE 101 may transmit a UE information response message including a RLF report. The RLF report may indicate failure information being at least one of: a RLF, a HOF, a first timer associated with a fast MCG link recovery procedure expiry, a DAPS HOF, and a CHO failure. In an embodiment of the present application, a DAPS HOF may mean a handover procedure that maintains a source base station (BS) connection, which is initiated after receiving a RRC message for DAPS handover, until releasing the source cell after a successful random access to a target BS. In step 505, the BS may receive the UE information response message including the RLF report.

According to some embodiments of the present application, the failure information, which is at least one of: the RLF, the HOF, and the first timer associated with a fast MCG link recovery procedure expiry, the DAPS HOF, and the CHO failure, may be indicated by a connection failure type indication in the RLF report. For example, the connection failure type indication may be a connectionFailureType-r16 information element (IE) as specified in 3GPP standard document TS 38.331.

According to some other embodiments of the present application, the failure information being the first timer associated with a fast MCG link recovery procedure expiry may indicated by a first indication in the RLF report. The first indication may be different from the connectionFailureType-r16 IE as specified in 3GPP standard document TS 38.331.

According to some yet other embodiments of the present application, the failure information being the DAPS HOF is indicated by a second indication in the RLF report. The second indication may be different from the connectionFailureType-r16 IE as specified in 3GPP standard document TS 38.331.

According to some yet other embodiments of the present application, the failure information being the CHO failure is indicated by a third indication in the RLF report. The third indication may be different from the connectionFailureType-r16 IE as specified in 3GPP standard document TS 38.331.

According to some yet other embodiments of the present application, in the case that the RLF report indicates a failure information being a RLF, the RLF report further includes cause information being at least one of the followings: a second timer started in response to transmitting a measurement report expiry, a RLF notification being received, an out-of-sync timer expiry, a random access problem occurrence, and a maximum number of retransmissions that has been reached.

In an embodiment of the present application, the second timer started in response to transmitting a measurement report may be T312 as specified in 3GPP standard documents. In this embodiment, the cause information may be t312-expiry.

In an embodiment of the present application, the received RLF notification may be a backhaul RLF notification received by the UE in a multi-hop system. In the multi-hop system, the UE may be connected to a donor node relayed by several integrated access and backhaul (IAB) nodes. In the case that a backhaul RLF recovery failure is detected at an IAB node, the IAB node may transmit a backhaul RLF indication to the UE. In such embodiment, the cause information may be a receipt of backhaul RLF notification.

In an embodiment of the present application, the out-of-sync timer expiry may be t310-expriy as specified in 3GPP standard documents. The random access problem occurrence may be randomAccessProblem as specified in 3GPP standard documents. A maximum number of retransmissions that has been reached may be rlc-MaxNumRetx as specified in 3GPP standard documents.

According to some embodiments of the present application, before receiving the UE information request, the UE 101 may receive fast MCG link recovery configuration information from a BS, for example, the MN 102 as shown in FIG. 1. In an embodiment of the present application, the fast MCG link recovery configuration information may include a value for a first timer associated with the fast MCG link recovery procedure. For example, the first timer may be T316 as specified in 3GPP standard documents. When the UE 101 receives the fast MCG link recovery configuration information, the UE 101 is allowed to use a fast MCG link recovery procedure when a RLF in a MCG happens. Then, in response to a MCG RLF (also referred to as a RLF in MCG), the UE 101 may initiate a fast MCG link recovery procedure and start the first timer associated with the fast MCG link recovery procedure.

In an embodiment of the present application, the UE 101 may receive a RRC reconfiguration message including reconfiguration with sync information element (IE) or a RRC release message while the first timer is running. The UE may stop the first timer in response to receiving the RRC reconfiguration message or the RRC release message. In such embodiment, the UE may include the time value of the first timer when stopping the first timer in the RLF report.

In another embodiment of the present application, in response to the first timer expiry, the UE 101 may initiate a RRC re-establishment procedure. For example, the UE may perform a cell selection procedure to select a cell and transmitting a RRC re-establishment request to the cell (or a BS). In the case that the RRC re-establishment procedure succeeds, the cell (or the BS) may transmit a UE information request to the UE 101. In the case that the RRC re-establishment procedure fails, the UE 101 may enter a RRC_IDLE state and may initiate a connection setup procedure to access the network. After the UE accesses a cell by the connection setup procedure, the cell (or the BS) may also transmit a UE information request to the UE 101. After receiving the UE information request, the UE may transmit the RLF report indicating the failure information being the first timer associated with a fast MCG link recovery procedure expiry to the cell.

In another embodiment of the present application, the UE may receive a RRC reconfiguration message including reconfiguration with sync IE while the first timer is running. In response to receiving the reconfiguration with sync IE, the UE may initiate a HO procedure and start a third timer associated with the HO procedure. For example, the third timer may be T304 as specified in 3GPP standard documents.

In response to the third timer expiry (e.g., the HO procedure failure), the UE may initiate a RRC re-establishment procedure. The UE may start a timer associated with a cell selection procedure (for example, T311 as specified in 3GPP standard documents) in response to initiating the RRC re-establishment procedure.

In the case that the UE selects a cell without CHO configuration during the timer associated with a cell selection procedure is running, the UE may transmit a RRC re-establishment request to a cell without CHO configuration. In the case that the RRC re-establishment procedure succeeds, the cell (or the BS) may transmit a UE information request to the UE 101. In the case that the RRC re-establishment procedure fails, the UE 101 may access a cell by a connection setup procedure. The cell (or the BS) may also transmit a UE information request to the UE 101 after the UE 101 accessed the network.

After receiving the UE information request, the UE may transmit the RLF report indicating the failure information being the RLF. The RLF report may also include at least one of: a cell identity of a cell from which the reconfiguration with sync IE is received, and a cell identity of a target cell indicated in the reconfiguration with sync IE. In an embodiment of the present application, the cell identity may be a cell global identifier (CGI). In another embodiment of the present application, the cell identity may be determined based on a physical cell identity and an absolute radio frequency channel number (ARFCN) value. In an embodiment of the present disclosure, the ARFCN value may refer to a value indicated by an ARFCN-ValueNR IE as specified in 3GPP standard documents. The ARFCN-ValueNR IE may be used to indicate the ARFCN applicable for a downlink, uplink or bi-directional (e.g., in the time-division duplex (TDD) mode) NR global frequency raster.

In the case that the UE selects a cell with CHO configuration while the timer associated with a cell selection procedure is running, the UE may perform a CHO procedure. In the case that the CHO procedure fails, the UE may continue the RRC re-establishment procedure. In the case that the RRC re-establishment procedure succeeds, the cell (or the BS) may transmit a UE information request to the UE 101. In the case that the RRC re-establishment procedure fails, the UE 101 may access a cell by a connection setup procedure. Whatever, the cell (or the BS) may also transmit a UE information request to the UE 101 after the UE accessed the network.

After receiving the UE information request, the UE may transmit the RLF report indicating the failure information being the RLF. The RLF report may also include at least one of: a cell identity of a cell from which the CHO configuration is received, a cell identity of the cell which is selected during the RRC re-establishment procedure for performing the CHO procedure, and a cell identity of a target cell indicated in the reconfiguration with sync IE. In an embodiment of the present application, the cell identity may be a CGI. In another embodiment of the present application, the cell identity may be determined based on a physical cell identity and an ARFCN value.

In an embodiment of the present application, the CHO configuration may be received by a conditional reconfiguration IE included in a RRC reconfiguration message. In such embodiment, a cell identity of a cell from which the CHO configuration is received may refer to the cell from which the conditional reconfiguration IE is received.

According to some other embodiments of the present application, the UE may initiate a RRC re-establishment procedure in response to one of: RLF, HOF, CHO failure, and DAPS HOF.

In some embodiments of the present application, in response to initiating a RRC re-establishment procedure due to the MCG RLF, the UE may transmit the RLF report indicating the failure information being a RLF. The RLF may be declared in response to one of the following: an out-of-sync timer expiry, a random access problem occurrence, a maximum number of retransmissions that has been reached, a beam failure recovery failure, a second timer started in response to transmitting a measurement report expires, and a RLF notification being received.

Specifically, in some embodiments of the present application, the out-of-sync timer may be T310 as specified in 3GPP standard documents. The T310 may be started when detecting physical layer problems for a SpCell, i.e. when receiving a number of consecutive out-of-sync indications from lower layers. The number of consecutive out-of-sync indications may be N310 as specified in 3GPP standard documents.

Specifically, in some embodiments of the present application, the random access problem may be indicated by an indication from a MCG medium access control (MAC) layer.

Specifically, in some embodiments of the present application, a maximum number of retransmissions being reached may be indicated by an indication from a MCG radio link control (RLC) layer.

Specifically, in some embodiments of the present application, the second timer started in response to that a measurement report is triggered may be T312 as specified in 3GPP standard documents.

Specifically, in some embodiments of the present application, the RLF notification being received may be a backhaul RLF notification received by the UE in a multi-hop system. In the multi-hop system, the UE may be connected to a donor node relayed by several IAB nodes. In the case that a backhaul RLF recovery failure is detected at an IAB node, the IAB node may transmit a backhaul RLF indication to the UE. In such embodiment, the cause information may be a receipt of backhaul RLF notification.

In some other embodiments of the present application, in response to initiating a RRC re-establishment procedure due to the HOF, the UE may transmit the RLF report indicating the failure information being a HOF.

In yet some yet other embodiments of the present application, in response to initiating a RRC re-establishment procedure due to the CHO failure, the UE may transmit the RLF report indicating the failure information being a CHO failure.

In yet some yet other embodiment of the present application, in response to initiating a RRC re-establishment procedure due to the DAPS HOF, the UE may transmit the RLF report indicating the failure information being DAPS HOF.

During a RRC re-establishment procedure, a UE may select a cell. In some embodiments of the present application, the UE may start a timer associated with a cell selection procedure (for example, T311 as specified in 3GPP standard documents) in response to initiating the RRC re-establishment procedure.

In the case that the UE selects a cell with CHO configuration during the timer associated with a cell selection procedure is running, the UE may perform a CHO procedure. In the case that the CHO procedure fails, the UE may continue the RRC re-establishment procedure. In the case that the RRC re-establishment procedure succeeds, the cell (or the BS) may transmit a UE information request to the UE 101. In the case that the RRC re-establishment procedure fails, the UE 101 may access a cell by a connection setup procedure. The cell (or the BS) may also transmit a UE information request to the UE 101 after the UE accessed the network. After receiving the UE information request, the UE may transmit the RLF report.

In an embodiment of the present application, the RLF report may also include a cell identity of a target cell of a CHO procedure performed by a UE during the RRC re-establishment procedure. In another embodiment of the present application, the RLF report may also include a cell identity of a cell from which the CHO configuration is received. In an embodiment of the present application, the cell identity may be a CGI. In another embodiment of the present application, the cell identity may be determined based on a physical cell identity and an ARFCN value.

Another exemplary scenario is about SCG failure report. In MR-DC, in the case that SCG RLF (or RLF in SCG) is detected, a UE may transmit SCG failure information to the MN. The RLF in the SCG may refer to the RLF happening in the PScell of the SCG. After receiving the SCG failure information, the MN may handle the SCG failure information to determine whether to keep, change, or release the SN and/or SCG for the UE.

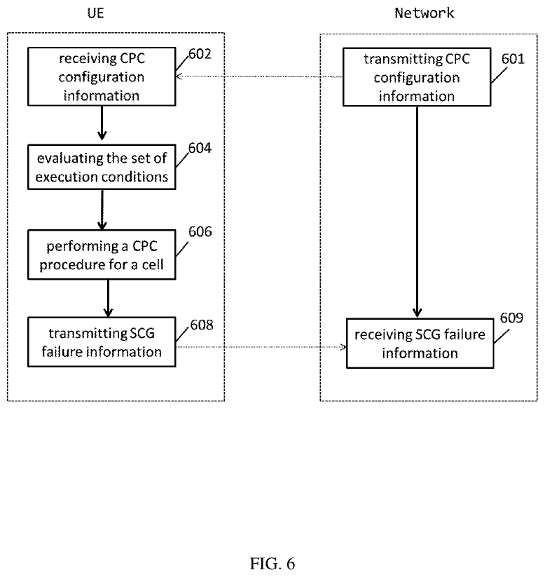

FIG. 6 illustrates a flow chart of a method for SCG failure report in accordance with some embodiments of the present application. The method may be performed between a UE, e.g., a UE 101 as shown in FIG. 1 and the network side (for example, MN 102 and/or SN 103 as shown in FIG. 1). For example, the UE 101 may be in the MR-DC scenario where the UE 101 connects to an MN 102 and an SN 103. In addition, persons skilled in the art should understand although the method is illustrated in the system level in FIG. 6, the method performed in UE 101 and that performed in the network side (e.g., the MN and/or SN) are separated. They can be applied in other network elements and can incorporate with other corresponding methods.

As shown in FIG. 6, in step 601, the MN 102 or the SN 103 may transmit CPC configuration information associated with a serving primary secondary cell (PScell) to a UE 101. In step 602, the UE 101 may receive the CPC configuration information associated with a serving primary secondary cell (PScell). The CPC configuration information may be received from the MN 102 or from the SN 103. The CPC configuration information may indicate a set of CPC configurations and a set of execution conditions for a set of cells, wherein each cell is associated with a CPC configuration and an execution condition.

The CPC configuration associated with a cell may include parameters for the UE to perform handover to the cell. For example, the CPC configuration associated with a cell may include parameters for the UE to access the cell and/or perform data transmission with the cell.

The execution condition may include one or two trigger conditions. For example, in the case that the execution condition includes one trigger condition, the trigger condition may be an A3 event or an A5 event as specified in 3GPP standard document TS38.331. In the case that the execution condition includes two trigger conditions, the two trigger conditions may be an A3 event and an A5 event as specified in 3GPP standard document TS38.331. In addition, only a single reference signal (RS) type may be used for evaluating the execution condition of a single cell and at most two different execution quantities can be configured simultaneously for evaluating the execution condition of a single cell. For example, the two different execution quantities may be reference signal receiving power (RSRP) and reference signal receiving quality (RSRQ), or RSRP and signal to interference plus noise ratio (SINR), or the like. In some embodiments of the present application, more than one execution condition may be satisfied, that is, more than one cell is suitable for the UE's handover. In this case, the UE can select a cell for performing CPC based on the execution quantity.

After receiving the CPC configuration information, in step 604, the UE 101 may evaluate the set of execution conditions based on the CPC configuration information.

In response to at least one execution condition of the set of execution conditions is met, in step 606, the UE may perform a CPC procedure for a cell associated with one met execution condition and start a fourth timer associated with the CPC procedure so as to change the serving PScell. For example, the cell may be selected from the at least one cell whose execution condition is met based on the signal quality. The CPC procedure may be similar as the CHO procedure as shown in FIG. 2. In an embodiment of the present application, the fourth timer associated with the CPC procedure may be T304 as specified 3GPP standard documents.

In response to the fourth timer expiry (e.g., CPC failure), in step 608, the UE may transmit SCG failure information indicating the CPC failure to the MN 102. In step 609, the network side may receive the transmitted SCG failure information.

According to some embodiments of the present application, in addition to the cause and measurement result, the SCG information may include at least one of: information indicating whether the serving PScell is experiencing a RLF or not, a status of the serving PScell, information indicating one or more cells of the set of cells for which the execution conditions are met but are not selected for performing the CPC procedure, and a fallback indication for fallback to the PScell. In an embodiment of the present application, the status of the serving PScell may refer to whether the out-of-sync timer (e.g., T310 as specified in 3GPP standard documents) is running.

In an embodiment of the present application, in the case that the serving PScell is not experiencing the RLF, the UE 101 may resume a connection to the serving PScell in response to a CPC failure. That is, in the case that the serving PScell is not experiencing the RLF, the UE 101 may perform fallback to the serving PScell when a CPC failure occurs.

In another embodiment of the present application, in the case that the serving PScell is not experiencing the RLF, the UE 101 may resume a part of radio bearers (RBs) or all RBs which were suspended in response to a fourth timer (e.g., T304) expiry.

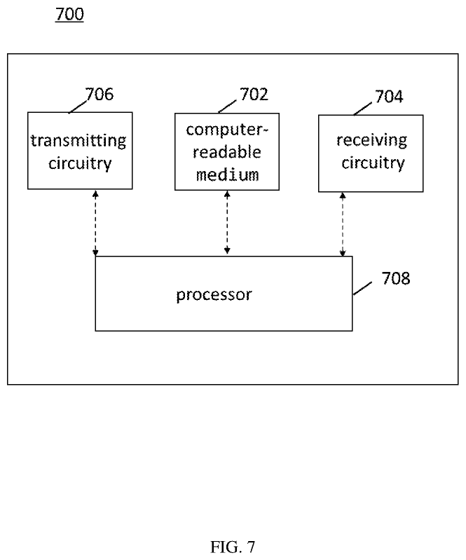

FIG. 7 illustrates a simplified block diagram of an apparatus 700 for RLF report according to some embodiments of the present application. The apparatus 700 may be a UE 101 as shown in FIG. 1.

Referring to FIG. 7, the apparatus 700 may include at least one non-transitory computer-readable medium 702, at least one receiving circuitry 704, at least one transmitting circuitry 706, and at least one processor 708. In some embodiment of the present application, at least one receiving circuitry 704 and at least one transmitting circuitry 706 and be integrated into at least one transceiver. The at least one non-transitory computer-readable medium 702 may have computer executable instructions stored therein. The at least one processor 708 may be coupled to the at least one non-transitory computer-readable medium 702, the at least one receiving circuitry 704 and the at least one transmitting circuitry 706. The computer executable instructions can be programmed to implement a method with the at least one receiving circuitry 704, the at least one transmitting circuitry 706 and the at least one processor 708. The method can be a method according to an embodiment of the present application, for example, the corresponding method shown in FIGS. 4, 5 and 6.

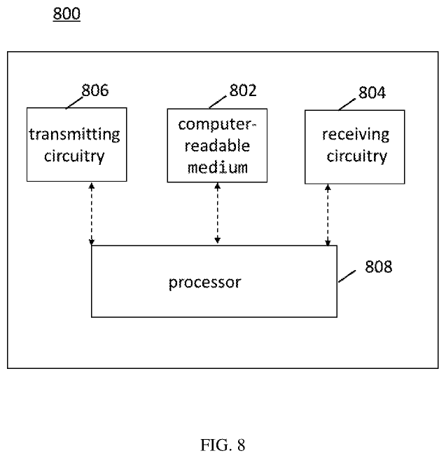

FIG. 8 illustrates a simplified block diagram of an apparatus 800 for RLF report according to some embodiments of the present application. The apparatus 800 may be a BS accessed by a UE 101 through a RRC re-establishment procedure or through a connection setup procedure, or may be a MN 102 or a SN 103 as shown in FIG. 1.

Referring to FIG. 8, the apparatus 800 may include at least one non-transitory computer-readable medium 802, at least one receiving circuitry 804, at least one transmitting circuitry 806, and at least one processor 808. In some embodiment of the present application, at least one receiving circuitry 804 and at least one transmitting circuitry 806 and be integrated into at least one transceiver. The at least one non-transitory computer-readable medium 802 may have computer executable instructions stored therein. The at least one processor 808 may be coupled to the at least one non-transitory computer-readable medium 802, the at least one receiving circuitry 804 and the at least one transmitting circuitry 806. The computer executable instructions can be programmed to implement a method with the at least one receiving circuitry 804, the at least one transmitting circuitry 806 and the at least one processor 808. The method can be a method according to an embodiment of the present application, for example, the corresponding method shown in FIGS. 4, 5 and 6.

The method according to embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this application. For example, an embodiment of the present application provides an apparatus for emotion recognition from speech, including a processor and a memory. Computer programmable instructions for implementing a method for emotion recognition from speech are stored in the memory, and the processor is configured to perform the computer programmable instructions to implement the method for emotion recognition from speech. The method may be a method as stated above or other method according to an embodiment of the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method for emotion recognition from speech as stated above or other method according to an embodiment of the present application.

While this application has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the application by simply employing the elements of the independent claims. Accordingly, embodiments of the application as set forth herein are intended to be illustrative, not limiting. Various changes may be made without departing from the spirit and scope of the application.

1. A method, comprising:
in response to accessing a cell by a radio resource control (RRC) re-establishment procedure or a connection setup procedure, receiving a user equipment (UE) information request; and
in response to the UE information request, transmitting a UE information response message including a radio link failure (RLF) report, wherein the RLF report indicates failure information being at least one of: a RLF, a handover (HO) failure (HOF), a first timer associated with a fast master cell group (MCG) link recovery procedure expiry, a dual active protocol stack (DAPS) HOF, and a conditional handover (CHO) failure.

2. The method of claim 1, wherein the failure information being at least one of: the RLF, the HOF, and the first timer associated with a fast MCG link recovery procedure expiry, the DAPS HOF, and the CHO failure is indicated by a connection failure type indication in the RLF report.

3. The method of claim 1, wherein the failure information being the first timer associated with a fast MCG link recovery procedure expiry is indicated by a first indication in the RLF report.

4. The method of claim 1, wherein the failure information being the DAPS HOF is indicated by a second indication in the RLF report.

5. (canceled)

6. The method of claim 1, wherein in a case that the RLF report indicates the failure information being a RLF, the RLF report further comprises cause information being at least one of:
a second timer started in response to transmitting a measurement report expiry;
a RLF notification being received;
an out-of-sync timer expiry;
a random access problem occurrence; and
a maximum number of retransmissions that has been reached.

7. (canceled)

8. (canceled)

9. (canceled)

10. (canceled)

11. (canceled)

12. (canceled)

13. (canceled)

14. (canceled)

15. The method of claim 1, comprising:
in response to initiating the RRC re-establishment procedure due to a MCG RLF, transmitting the RLF report indicating the failure information being a RLF;
wherein the RLF is declared in response to one of:
an out-of-sync timer expiry;
a random access problem occurrence;
a maximum number of retransmissions that has been reached;
a beam failure recovery failure;
a second timer started in response to transmitting a measurement report expires; and
a RLF notification being received.

16. (canceled)

17. (canceled)

18. (canceled)

19. (canceled)

20. (canceled)

21. (canceled)

22. (canceled)

23. (canceled)

24. A method, comprising:
transmitting a user equipment (UE) information request; and
in response to the UE information request, receiving a UE information response message including a radio link failure (RLF) report, wherein the RLF report indicates failure information being at least one of: a RLF, a handover (HO) failure (HOF), a first timer associated with a fast master cell group (MCG) link recovery procedure expiry, a dual active protocol stack (DAPS) HOF, and a conditional handover (CHO) failure.

25. (canceled)

26. (canceled)

27. (canceled)

28. (canceled)

29. The method of claim 24, wherein in a case that the RLF report indicates the failure information being a RLF, the RLF report further comprises cause information being at least one of:
a second timer started in response to transmitting a measurement report expires;
a RLF notification being received;
an out-of-sync timer expiry;
a random access problem occurrence; and
a maximum number of retransmissions that has been reached.

30. (canceled)

31. (canceled)

32. (canceled)

33. (canceled)

34. (canceled)

35. (canceled)

36. (canceled)

37. An apparatus, comprising:
a receiving circuitry;
a transmitting circuitry; and
a processor coupled to the receiving circuitry and the transmitting circuitry, configured to cause the apparatus to:
receive, in response to accessing a cell by a radio resource control (RRC) re-establishment procedure or a connection setup procedure, a user equipment (UE) information request and
transmit, in response to the UE information request, a UE information response message including a radio link failure (RLF) report, wherein the RLF report indicates failure information that includes at least one of: an RLF, a handover (HO) failure (HOF), a first timer associated with a fast master cell group (MCG) link recovery procedure expiry, a dual active protocol stack (DAPS) HOF, and a conditional handover (CHO) failure.

38. (canceled)

39. (canceled)

40. (canceled)

41. The apparatus of claim 37, wherein the failure information being at least one of: the RLF, the HOF, and the first timer associated with a fast MCG link recovery procedure expiry, the DAPS HOF, and the CHO failure is indicated by a connection failure type indication in the RLF report.

42. The apparatus of claim 37, wherein the failure information being the first timer associated with a fast MCG link recovery procedure expiry is indicated by a first indication in the RLF report.

43. The apparatus of claim 37, wherein the failure information being the DAPS HOF is indicated by a second indication in the RLF report.

44. The apparatus of claim 37, wherein the failure information being the CHO failure is indicated by a third indication in the RLF report.

45. The apparatus of claim 37, wherein in a case that the RLF report indicates the failure information being a RLF, the RLF report further comprises cause information that is at least one of:
a second timer started in response to transmitting a measurement report expiry;
a RLF notification being received;
an out-of-sync timer expiry;
a random access problem occurrence; and
a maximum number of retransmissions that has been reached.

46. The apparatus of claim 37, the processor, the receiving circuitry, and the transmitting circuitry further configured to cause the apparatus to:
receive fast MCG link recovery configuration information; and
in response to a MCG RLF, initiate a fast MCG link recovery procedure and starting the first timer associated with the fast MCG link recovery procedure.

47. The apparatus of claim 46, the processor, the receiving circuitry, and the transmitting circuitry further configured to cause the apparatus to:
stop the first timer in response to receiving a RRC reconfiguration message or a RRC release message while the first timer is running; and
include a time value of the first timer when stopping the first timer in the RLF report.

48. The apparatus of claim 46, the processor, the receiving circuitry, and the transmitting circuitry further configured to cause the apparatus to:
in response to the first timer expiry, initiate the RRC re-establishment procedure; and
transmit the RLF report indicating the failure information being the first timer associated with a fast MCG link recovery procedure expiry.

49. The apparatus of claim 46, the processor, the receiving circuitry, and the transmitting circuitry further configured to cause the apparatus to:
receive a RRC reconfiguration message including reconfiguration with sync information element (IE) while the first timer is running; and
in response to receiving the reconfiguration with sync IE, initiate a HO procedure and starting a third timer associated with the HO procedure.

50. The apparatus of claim 37, the processor, the receiving circuitry, and the transmitting circuitry further configured to cause the apparatus to:
in response to initiating the RRC re-establishment procedure due to a MCG RLF, transmit the RLF report indicating the failure information being a RLF;
wherein the RLF is declared in response to one of:
an out-of-sync timer expiry;
a random access problem occurrence;
a maximum number of retransmissions that has been reached;
a beam failure recovery failure;
a second timer started in response to transmitting a measurement report expires; and
a RLF notification being received.

51. The apparatus of claim 37, the processor, the receiving circuitry, and the transmitting circuitry further configured to cause the apparatus to:
perform a CHO procedure for a cell selected during the RRC re-establishment procedure in a case that the cell has CHO configuration.
